(19) United States
(12) Patent Application Publication
(10) Pub. No.: US 2010/0299229 A1
(43) Pub. Date: Nov. 25, 2010

(54) CAPABILITIES AND OPTIONS FOR DISTRIBUTING FUNCTIONALITY IN AN ENTERPRISE RESOURCE PLANNING SYSTEM LANDSCAPE

(75) Inventor: Lothar RIEGER, Bammental (DE)

Correspondence Address: KENYON & KENYON LLP, 1500 K STREET N.W., WASHINGTON, DC, 20005, US

(73) Assignee: SAP AG, Walldorf (DE)

(21) Appl. No.: 12/469,218

(22) Filed: May 20, 2009

(51) Int. Cl. G06Q 10/00

(52) U.S. Cl. 705/30; 705/34

(57) ABSTRACT

A system and method for distributing computing operations across multiple systems in an enterprise resource planning system is provided. In an embodiment, notifications are used to exchange information updates between the systems. In an embodiment, notifications containing financial data are sent to an accounting system. The accounting system may extract the financial data from the notification, use accounting logic in the accounting system to associate the financial data with a general ledger account maintained by the accounting system, and post an accounting entry in a financial document to properly credit and/or debit the account.

### BACKGROUND

Many large businesses rely on enterprise resource planning computing architectures and systems to electronically manage and coordinate business resources, information, and functions. In large organizations these computing architectures may distribute functionality across many different systems. For example, a global business may rely on location-specific logistics systems to process orders in different localities, division specific supply chain management systems to manage supply chains across geographies, and business specific accounting systems to manage financial transactions at a business level.

While many enterprise resource planning architectures support distributing computing functions across a plurality of systems, in many instances these architectures rely on single systems to perform calculations, transformations, or other operations relating to one or more other systems, with the results stored locally on these systems and then replicated to the other systems. FIG. 1 provides one example of an enterprise resource planning system relying on a single system—in this case the logistics system 10—to perform centralized calculations and transformations of data related to another system—in this case the accounting system 16. In this enterprise architecture, the accounting system 16 merely stores data object(s) representing a list of general ledger accounts 17 for posting various financial transactions and stores data object(s) representing a list of replicated financial documents containing financial transaction posted to one or more general ledger accounts 17.

Because the accounting system 16 primarily stores objects, the general ledger accounts 17 from the accounting system 16 are replicated 12 to logistics system 10 in order to identify ledger accounts associated with a financial transaction. The logistics system 10 then uses transaction data 11 corresponding to a transaction processed by the logistics system 10 together with the replicated account information 12 and accounting logic 13 to identify the appropriate accounts relating to the transaction data 11. After identifying the appropriate account, the logistics system 10 generates a financial document 14 to record the financial transaction associated with the identified account. The financial document 14 is then replicated back to the account system 16 and it is also stored locally in a financial database 15 on the logistics system 10.

There are several limitations presented by this architecture. First, because data, such as the general ledger accounts 17 and financial documents 14, is being replicated between the accounting 16 and logistics 10 systems, there are data consistency issues. Second, while the logistics system 10 and accounting system 16 are technically two separate systems, an organization can not merely upgrade or switch its accounting system 16 to gain additional features or functionality because the accounting calculations, operations, and logic are on the logistics system 10. Similarly, an organization seeking to upgrade its accounting system 16 may also have to unnecessarily upgrade its logistics system 10 as well since the accounting functions are on the logistics system 10. Third, since the accounting transactions, calculations, and operations are conducted through the logistics system 10, users seeking to modify accounting operations must be able to access the logistics system as well, resulting in additional security concerns.

The aforementioned limitations become even greater concerns when a plurality of logistics systems 10a, b, and c, are introduced as shown in FIG. 2. Preserving consistency and maintaining data between the general ledger accounts 17 and replicated accounts 12a, b, and c, and financial documents 14a, b, and c, financial databases 15a, b, and c, and replicated documents 18, consumes additional resources and becomes even more difficult. The expense associated with upgrading logistics system 10a, b, and c to gain additional accounting related functionality becomes even greater. The security concerns of having accounting users access a plurality of logistics systems 10a, b, and c to modifying accounting functionality also increase.

While the aforementioned example relates to an accounting system 16 and logistics system 10, the example is applicable to variety of different architectures with different systems that rely on one system to perform calculations, transformations, or other operations on behalf of another system. In other words, instead of logistics system 10 and accounting system 16, the example applies equally to other types of systems, such as purchasing systems, supply chain systems, human resources systems, customer service systems, data management systems, and other systems.

There is thus a need for an enterprise resource planning system that decentralizes operations by distributing data calculation, transformation, and operations across different computing systems according to the role of the system.

### BRIEF DESCRIPTION OF THE DRAWINGS

FIG. 1 shows interactions between components among and within a logistics system and an accounting system in an exemplary enterprise resource planning architecture.

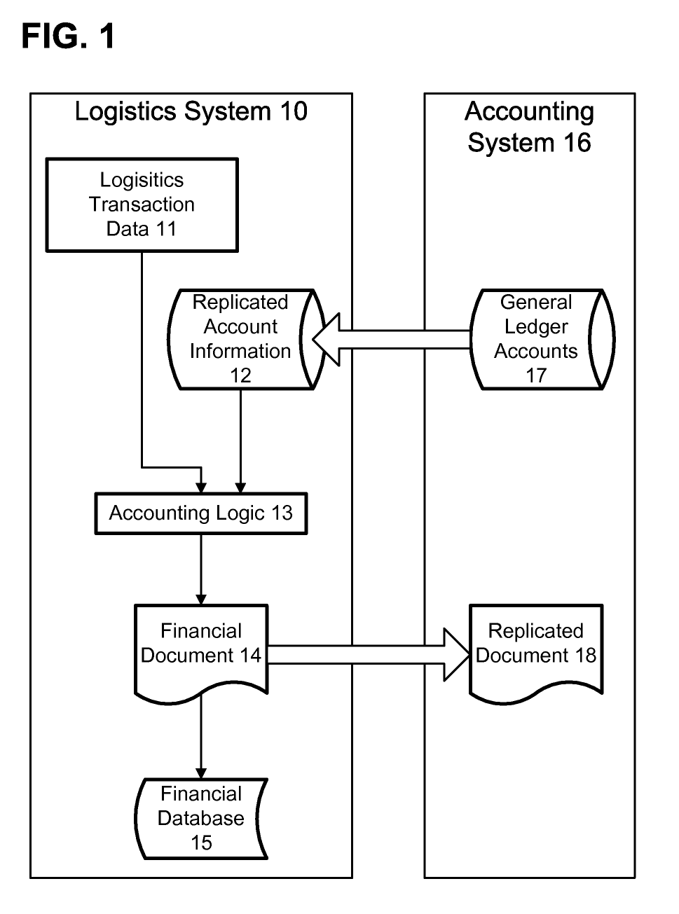

FIG. 2 shows higher level components and interactions in an exemplary enterprise resource planning architecture containing at least three logistics systems and one accounting system.

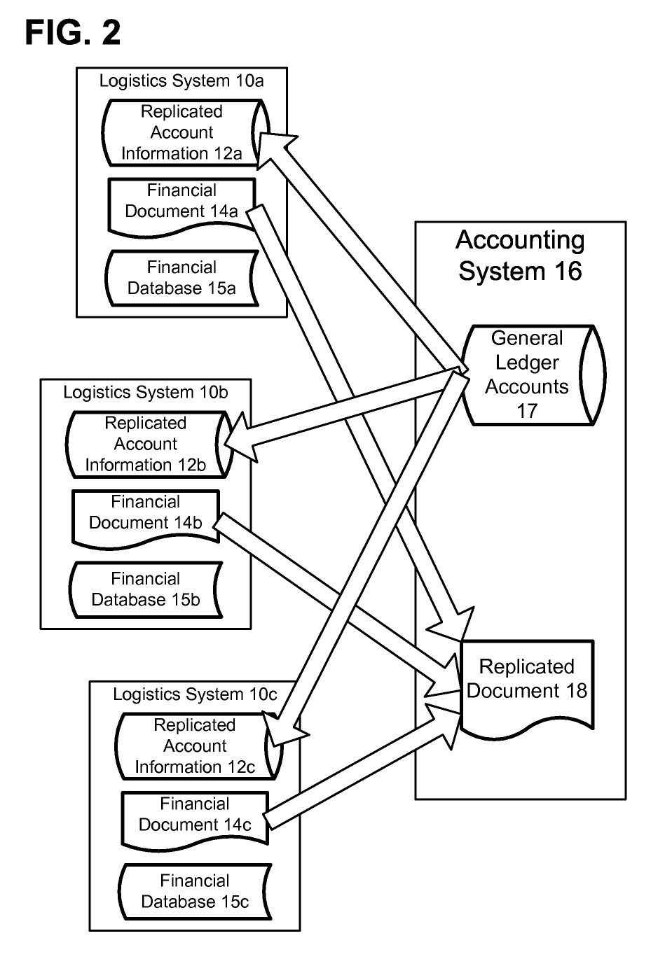

FIG. 3 shows the interactivity between various components in multiple logistics systems and one accounting system in one embodiment of an enterprise resource planning system.

FIG. 4 shows elements of an embodiment relating to the exchange of goods involving a logistics system 31, invoice system 47, and accounting system 34 in an enterprise resource planning system.

FIG. 5 shows elements of an embodiment relating to the exchange of goods involving interactions between one or more systems and accounting system 34 in an enterprise resource planning system.

FIG. 6 shows elements of an embodiment relating to the production of goods involving interactions between one or more systems and the accounting system 34 in an enterprise resource planning system.

FIG. 7 shows an embodiment of an enterprise resource planning system.

### DETAILED DESCRIPTION

An embodiment of the invention may include an enterprise resource planning system including an accounting system that receives notifications containing financial data from a logistics system after the logistics system has processed a transaction relating to the procurement, maintenance, or transportation of materials, facilities, or personnel. Once the accounting system receives the notification, it may extract and/or convert the financial data to identify a general ledger account associated with the financial data. After identifying the account, the accounting system may generate and post an accounting entry for the financial data in a financial document which may then be stored in the accounting system.

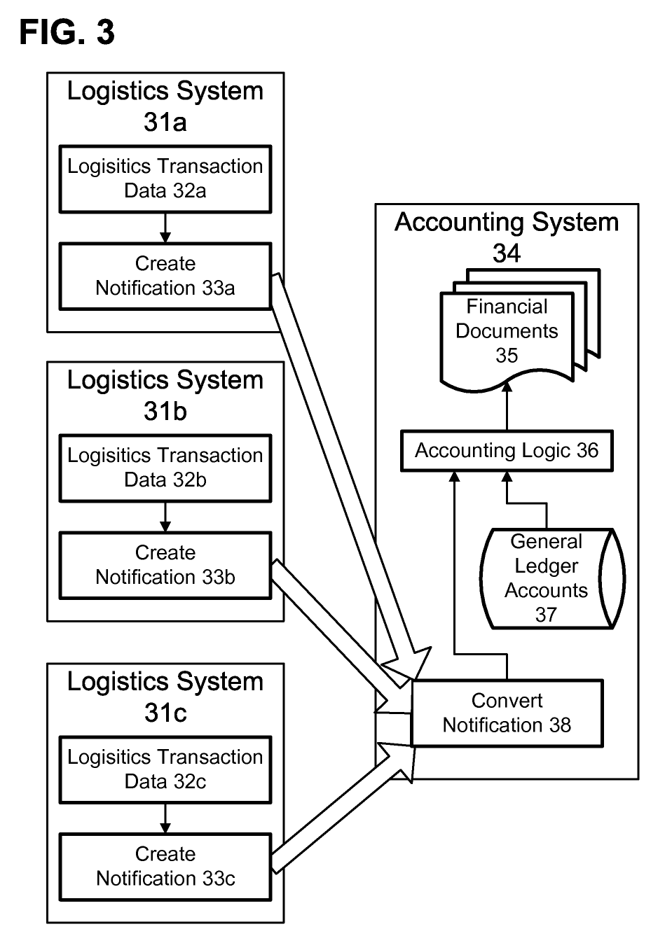

An embodiment shown in FIG. 3, for example, shows the interactivity between various components in different logistics systems 31a, b, and c, and an accounting system 34 in an enterprise resource planning system. In this embodiment, each of the logistics systems 31a, b, and c, may contain logistics-related software or logic to, for example, process a transaction, purchase requisition, purchase order, goods receipt, invoice, bill of lading, or the like. During or after processing a transaction or document, the logistics systems 31a, b, and c, may extract data related to the transaction 32a, b, and c, which is then reformatted by the logistics systems 31a, b, and c into a notification 33a, b, and c, using a predetermined messaging protocol and sent to accounting system 34. Each type of business transaction may have a different interface format. For example, purchase order data may be structured in format “A”, whereas goods receipt data may be structured in format “B”. Thus, if notification 33a contains purchase order data, the notification data may have interface structure “A”, while if notifications 33b and c contain goods receipt data, the notification data may have interface structure “B”. Accounting system 34 may contain a converter to read and/or process the financial data in multiple formats, including format “A” data from logistics system 31a, and format “B” data from logistics systems 31b and c.

Once the notifications have been received by accounting system 34, the transaction data 32 may be extracted and/or converted from the notification 38. Accounting system 34 may then use accounting logic 36 to identify which account(s) in a database of general ledger accounts 37, which may be maintained by the accounting system 34, may be applicable for reporting the transaction data 32. Based on the accounting logic 36, the accounting system 34 may generate a financial document 35 posting or recording the financial transaction involving the transaction data 32 and the account(s) from the general ledger 37. This technique of using accounting logic 36 in conjunction with general ledger account information 37 and data contained in a notification received by the accounting system 34 to generate and/or post a financial document 35 may be used in other embodiments described herein to generate and/or post other financial documents 35.

In an embodiment the financial document data 35, general ledger account information 37, and other accounting data may be maintained centrally by the accounting system 34, eliminating any replication of accounting data to other systems. In an embodiment, logistics related data, such as transaction data 32, may be maintained centrally by the logistics system generating the data, eliminating any replication of logistics data to other systems.

In an embodiment the accounting system 34 may be upgraded and/or replaced by a third party accounting system 34 supporting a standardized or predetermined messaging protocol without the need to upgrade other systems. In an embodiment any of the logistics systems 31a, b, or c, may be upgraded and/or replaced by a third party logistics systems supporting a standardized or predetermined messaging protocol without the need to upgrade other systems.

In an embodiment access to the accounting system 34 may be restricted to a subset of users of the accounting system. In an embodiment access to the logistics system 31a, b, and c, may be restricted to a subset of users of the respective logistics systems.

In an embodiment a record of a notification being sent or received is stored for a specified period. In an embodiment a confirmation is sent after successfully receiving a notification. In an embodiment a record of notification being sent or received is deleted after sending or receiving a confirmation.

In an embodiment notifications are sent in XML format. In an embodiment notifications are sent using a web-based communications protocol.

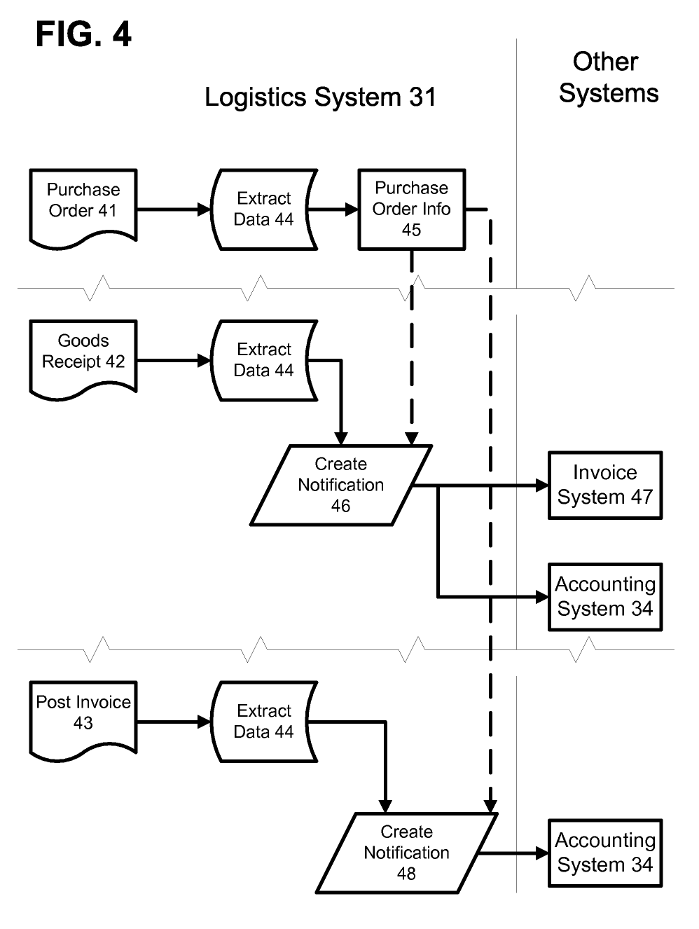

FIG. 4 shows elements of an embodiment relating to the exchange of goods involving a logistics system 31, invoice system 47, and accounting system 34 in an enterprise resource planning system. In FIG. 4, logistics system 31 may initially receive a purchase order 41. The logistics system 31 may then extract data 44 from the purchase order, and may store 45 some extracted identifying information from the purchase order in the logistics system 31. At some later time, logistics system 31 may receive a goods receipt 42, at which time the logistics system 31 may extract identifying data 42 from the good receipts. Logistics system 31 may also generate one or more notifications 46 based on the extracted data from the goods receipt 42. For example, the logistics system 31 may asynchronously generate and/or send a notification to the accounting system 34 containing extracted information from the goods receipt 42 and/or stored purchase order information 45, so that the accounting system 34 can generate and/or post corresponding financial documents 35. The logistics system 31 may also asynchronously generate and/or send a notification to an invoice management system 47 containing either the goods receipt 42 or data extracted from the goods receipt 42 and/or stored data extracted from the purchase order 45. The invoice management system 47 may further process the good receipt 42 to verify or reconcile the goods receipt with other financial records, such budget records and other types of financial records. The invoice management system 47 may then send its own notification to the accounting system 34 and/or logistics system 31, to report the results of its further processing.

Sometime later, the invoice may get posted 43. Although FIG. 4 shows the invoice posted 43 to the logistics system, the invoice may be posted at, to, or by other systems. For example, the invoice management system 47, may post the invoice 43 as part of the results of its further processing. Once the invoice has been posted 43, a notification 48 may be asynchronously generated and sent to the accounting system 34, so that the accounting system 34 may create and post corresponding financial documents 35.

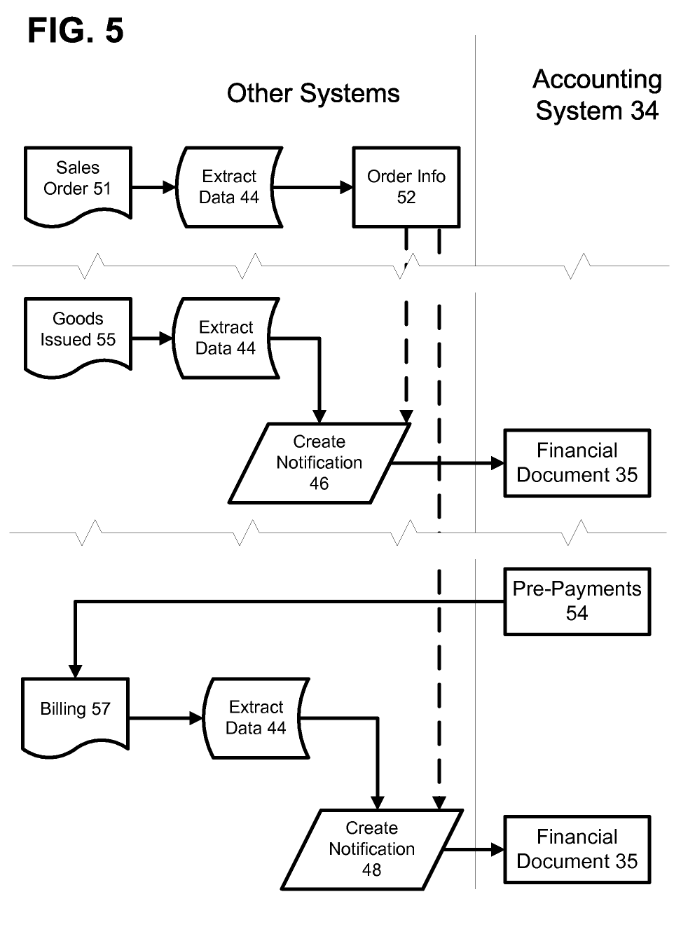

FIG. 5 shows elements of an embodiment relating to the exchange of goods involving interactions between one or more systems and accounting system 34 in an enterprise resource planning system. When a first system in the enterprise receives a sales order 51, the system may extract identifying data 44 from the sales order 51 and may store some of the extracted data 52. This data 52 may be stored within the system receiving the order 51, or in a database of a third system. Some time later, a second system may be informed that goods were issued 55. The second system, which may be the same system as the first system, then extracts data 44 from the goods issued notice 55. Using data extracted from the goods issued notice 55, and in some embodiments stored order information data 52, the second system may generate and/or send aggregated and asynchronous notifications to the accounting system 34, which may then create and post financial documents based on the extracted data in the notification.

Sometime later, the accounting system 34 may record one or more pre-payments 54 related to the sales order 51 and goods issued 55. When this happens, a fourth system, which may be the same or different system from the other three systems, may synchronously read pre-payment information 54 from the accounting system 34. Pre-payment information 54 may used, for example, to credit or subtract advance payments from a total balance due to ensure that a customer is billed the correct amount. When billing information 57 is received by the fourth system, the fourth system may extract billing data from the information 57 and generate and/or send an aggregated and asynchronous notification to the accounting system 34. This notification may include extracted billing information 57, pre-payment information 54, and/or order information 52. The accounting system 34, may generate a financial document 35 based on the notification.

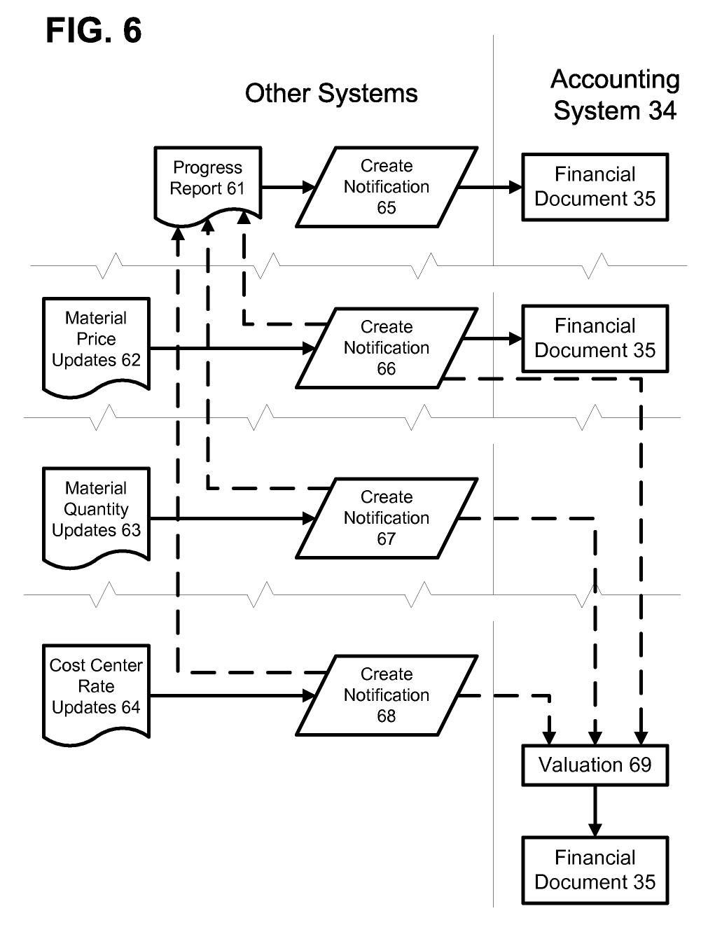

FIG. 6 shows elements of an embodiment relating to the production of goods involving interactions between one or more systems and the accounting system 34 in an enterprise resource planning system. In various embodiments, during the production or manufacturing process, production related data may be updated at different intervals and frequencies. For example, price updates 62 of materials used during production, may be received at different times and frequencies than quantity updates 63 of materials used, which may also be received at different times and frequencies than cost center rate updates 64. In an embodiment when price updates 62 are received at a system, the system may then generate and send notifications 66 to the accounting system 34 and/or a second system storing the price updates as progress reports 61. The notifications 66 may be aggregated and distributed asynchronously to the accounting system 34 and/or second system at specified intervals or under specified conditions.

Once the accounting system 34 receives the notification 66, it may then generate and post a financial document 35 relating to the price update 62. The accounting system 34 may use the price update 62 in combination with a quantity update 63 received through notification 67 before or after price update 62 and/or a cost center rate update 64 received through notification 68 before or after the price update 62 and/or quantity update 63 to calculate an updated valuation 69 using, for example, accounting logic 36. The accounting system 34 may then create and/or post a financial document 35 based on the updated valuation 69. The price updates 62, quantity updates 63, and cost center rate updates 64 may be calculated or received by one system or a plurality of different systems.

In various embodiments when quantity updates 63 and/or cost center rate updates 64 are received at one or more systems, the systems may then generate and send notifications 67 and 68 to the accounting system 34 and/or a second system storing the quantity updates 63 and/or cost center rate updates 64 as progress reports 61. The notifications 66 may be aggregated and distributed asynchronously to the accounting system 34 and/or second system at specified intervals or under specified conditions. The second system storing the progress reports 61 may then generate and send notifications 65 to the accounting system 34 and/or other systems depending on the settings of the second system. The accounting system 34 may create and/or post financial documents 35 based on the notifications 65 containing data from one or more progress reports 61. The notifications 65 may be aggregated and distributed asynchronously to the accounting system 34 and/or other systems at specified intervals or under specified conditions.

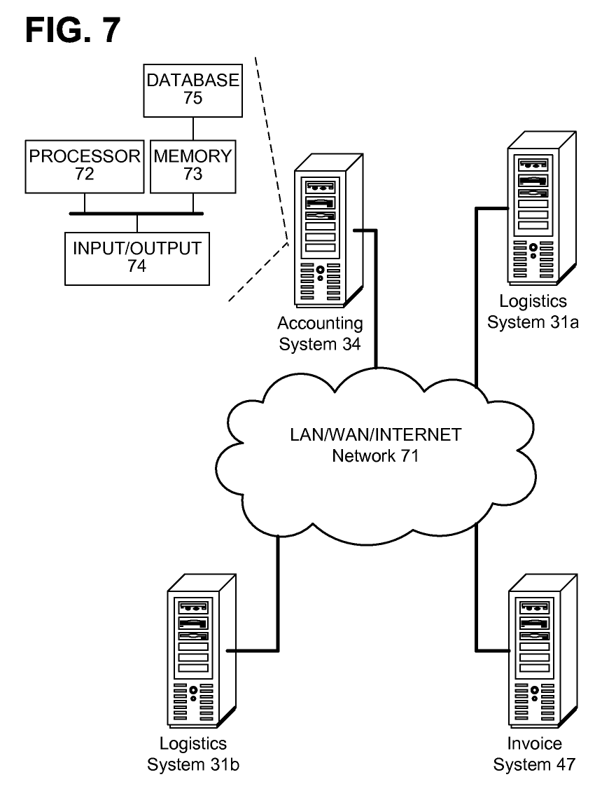

FIG. 7 shows an embodiment of an enterprise resource planning system landscape. In this embodiment, the accounting system 34, logistics systems 31a and 31b, and invoice system 47 are all interconnected through network 71. Each of the systems in FIG. 7 may contain a processor 72, memory 73 containing a database 75, and an input/output interface 74, all of which are interconnected via a system bus. In various embodiments, the enterprise resource planning system may have an architecture with modular hardware and/or software systems that include additional and/or different systems that communicate through one or more networks. The modular design allows a business to add, exchange, and upgrade systems, including, in some embodiments using systems from different vendors. Because of the highly customized nature of enterprise resource planning systems, different embodiments may have different types, quantities, and configurations of systems depending on the environment and organizational demands.

In an embodiment, memory 73 may contain different components for retrieving, presenting, changing, and saving data. Memory 73 may include a variety of memory devices, for example, Dynamic Random Access Memory (DRAM), Static RAM (SRAM), flash memory, cache memory, and other memory devices. Additionally, for example, memory 73 and processor(s) 72 may be distributed across several different computers that collectively comprise a system.

Processor 72 may perform computation and control functions of a system and comprises a suitable central processing unit (CPU). Processor 72 may comprise a single integrated circuit, such as a microprocessor, or may comprise any suitable number of integrated circuit devices and/or circuit boards working in cooperation to accomplish the functions of a processor. Processor 72 may execute computer programs, such as object-oriented computer programs, within memory 73.

Note that while embodiments of the present invention are described in the context of a fully functional computer system, those skilled in the art will appreciate that modules of the present invention are capable of being distributed in a variety of forms across a plurality of systems. Embodiments consistent with the invention may also include one or more programs or program modules on different computing systems running separately and independently of each other, while in their entirety being capable of performing business transactions in a large enterprise environment or in a “software on demand” environment. These programs or program modules may be contained on signal bearing media that may include: recordable type media such as floppy disks and CD ROMS, and transmission type media such as digital and analog communication links, including wireless communication links.

The foregoing description has been presented for purposes of illustration and description. It is not exhaustive and does not limit embodiments of the invention to the precise forms disclosed. Modifications and variations are possible in light of the above teachings or may be acquired from the practicing embodiments consistent with the invention. For example, some of the described embodiments may include software and hardware, but some systems and methods consistent with the present invention may be implemented in software or hardware alone. Additionally, although aspects of the present invention are described as being stored in memory, one skilled in the art will appreciate that these aspects can also be stored on other types of computer-readable media, such as secondary storage devices, for example, hard disks, floppy disks, or CD-ROM; the Internet or other propagation medium; or other forms of RAM or ROM.

We claim:

1. A system comprising:
an enterprise resource planning system including an accounting system maintaining a database of general ledger accounts, and the accounting system containing a processor operative to:
receive a notification from a logistics system in the enterprise resource planning system, the notification containing financial data relating to a transaction that has been performed by the logistics system;
extract the financial data from the notification;
identify a general ledger account associated with the financial data using accounting logic, the accounting logic containing a criteria for associating the financial data with the general ledger account;
generate an accounting entry for the transaction containing the financial data and the identified general ledger account;
post the accounting entry in a financial document; and
store the financial document in the accounting system.

2. The system of claim 1, where the financial data in the notification received by the accounting system is in a logistics system format specified by the logistics system and is converted to an accounting system format at the accounting system.

3. The system of claim 2, where the financial data is in XML in the notification and the notification is sent asynchronously.

4. The system of claim 2, where the financial data is converted to the accounting system format when the financial data is extracted from the notification.

5. The system of claim 1, the logistics system operative to:
responsive to receiving a purchase order, extract purchase order information from the purchase order, the purchase order information identifying the purchase order, a price, and a product ordered;
responsive to receiving a goods receipt, extract goods receipt information from the goods receipt, the goods receipt information identifying the purchase order and a received product,
compare the extracted goods receipt information to the extracted purchase order information to identify the price of the received product;
create the notification containing the financial data, the financial data including information identifying the purchase order, the received product, and the price of the received product; and
send the notification to the accounting system.

6. The system of claim 5, the logistics system further operative to:
responsive to receiving a posted invoice, extract invoice information from the posted invoice, the invoice information identifying the purchase order and a payment due;
compare the extracted invoice information to the extracted purchase order information to correlate the payment due to the purchase order when the extracted invoice information does not directly identify the purchase order;
create an additional notification containing additional financial data, the additional financial data including information identifying the purchase order and the payment due; and
send the additional notification to the accounting system, the additional notification being processed by the accounting system in the same manner as the notification.

7. The system of claim 6, further comprising an invoice system,
the logistics system further operative to send the notification to the invoice system,
the invoice system operative to:
responsive to receiving the notification from the logistics system, extract the financial data from the notification;
generate an invoice using the financial data; and
post the invoice, the posted invoice being sent to the logistics system.

8. The system of claim 7, where notifications are aggregated and sent asynchronously when the aggregated notifications reach a specified threshold.

9. The system of claim 1, the logistics system operative to:
responsive to receiving a sales order, extract sales order information from the sales order, the sales order information identifying the sales order, a sales price, and a product sold;
responsive to receiving a goods issued, extract goods issued information from the goods issued, the goods issued information identifying the sales order and an issued product,
compare the extracted goods issued information to the extracted sales order information to identify the sales price of the issued product;
create the notification containing the financial data, the financial data including information identifying the sales order, the issued product, and the sales price of the issued product; and
send the notification to the accounting system.

10. The system of claim 9, the logistics system further operative to:
responsive to receiving a billing update, extract billing information from the billing update, the billing information identifying the sales order and a balance due;
compare the extracted billing information to the extracted sales order information to correlate the balance due to the sales order when the extracted billing information does not directly identify the sales order;
create an additional notification containing additional financial data, the additional financial data including information identifying the sales order and the balance due; and
send the additional notification to the accounting system, the additional notification being processed by the accounting system in the same manner as the notification.

11. The system of claim 10, where the logistics system synchronously receives billing updates from the accounting system when the accounting system posts a billing update.

12. The system of claim 11, where the billing update includes a payment relating to the sales order.

13. The system of claim 12, where the logistics system comprises a plurality of computer systems for different tasks, the plurality of computer systems including a sales order computer system for receiving the sales order and extracting the sales order information; a goods receipt computer system for receiving the goods receipt and extracting the goods receipt information; and, a billing computer system for receiving the billing update, extracting billing information, and comparing the extracted billing information to the extracted sales order information.

14. The system of claim 1, the logistics system operative to:
responsive to receiving a price update for a material, extract price information from the price update, the price information identifying the material and a price of the material;
create a price update notification containing financial data including the price information;
responsive to receiving a quantity update for the material, extract quantity information from the quantity update, the quantity information identifying the material and a quantity of the material;
create a quantity update notification containing financial data including the quantity information.
responsive to receiving a cost center rate update for the material, extract rate information from the cost center rate update, the rate information identifying the material, a cost center using the material, and a rate of the cost center;
create a rate update notification containing financial data including the rate information;
asynchronously send at least one of the price update, the quantity update, and the rate update notifications to the accounting system; and
the accounting system further operative to:
using the accounting logic, update costs associated with the material based on at least one of the price information, the quantity information, and the rate information; and
post the updated costs associated with the material as an accounting entry in the financial document.

15. The system of claim 14, where:
the logistics system asynchronously sends at least one of the price update, the quantity update, and the rate update notifications to a second computing system, the second computing system storing at least one of the price information, the quantity information, and the rate information as a progress report relating to a task;
the second computer system asynchronously sends notifications to the accounting system, the notifications containing the progress report and identifying the task; and
the accounting system, using the accounting logic, updates costs associated with the task based on at least one of the price information, the quantity information, and the rate information in the progress report, and posts the updated costs associated with the material as an accounting entry in the financial document.

16. A computer-implemented method of using an enterprise resource planning system, comprising:
receiving a notification at an accounting computing system in the enterprise resource planning system from a logistics system in the enterprise resource planning system, the notification containing financial data relating to a transaction to be posted to a financial account;
extracting the financial data from the notification;
identifying a general ledger account associated with the financial data using accounting logic, the accounting logic containing a criteria for associating the financial data with the general ledger account;
generating an accounting entry for the transaction containing the financial data and the identified general ledger account;
posting the accounting entry in a financial document; and
storing the financial document in the accounting system.

17. The method of claim 16, where the notification is sent to the accounting system using an Internet communications protocol, the financial data is in XML in the notification, and the notification is sent asynchronously.

18. The method of claim 16, where the logistics computing system:
responsive to receiving a price update for a material, extracts price information from the price update, the price information identifying the material and a price of the material and creates a price update notification containing financial data including the price information;
responsive to receiving a quantity update for the material, extracts quantity information from the quantity update, the quantity information identifying the material and a quantity of the material and creates a quantity update notification containing financial data including the quantity information;
responsive to receiving a cost center rate update for the material, extracts rate information from the cost center rate update, the rate information identifying the material, a cost center using the material, and a rate of the cost center and creates a rate update notification containing financial data including the rate information;
asynchronously sends at least one of the price update, the quantity update, and the rate update notifications to the accounting system; and,
the accounting system, using the accounting logic, updates costs associated with the material based on at least one of the price information, the quantity information, and the rate information and posts the updated costs associated with the material as an accounting entry in the financial document.

19. An article of manufacture containing a computer-readable medium storing program instructions that, when executed by a processor, cause the processor to perform actions comprising:
responsive to receiving a notification at an accounting computing system in the enterprise resource planning system from a logistics system in the enterprise resource planning system, the notification containing financial data relating to a transaction to be posted to a financial account, extracting the financial data from the notification;
identifying a general ledger account associated with the financial data using accounting logic, the accounting logic containing a criteria for associating the financial data with the general ledger account;
generating an accounting entry for the transaction containing the financial data and the identified general ledger account;
posting the accounting entry in a financial document; and
storing the financial document in the accounting system.

20. The article of claim 19, the computer-readable medium storing further program instructions that, when executed by the processor, cause the processor to perform actions further comprising:
responsive to receiving a price update for a material, extracting price information from the price update, the price information identifying the material and a price of the material and creates a price update notification containing financial data including the price information;
responsive to receiving a quantity update for the material, extracting quantity information from the quantity update, the quantity information identifying the material and a quantity of the material and creates a quantity update notification containing financial data including the quantity information;
responsive to receiving a cost center rate update for the material, extracting rate information from the cost center rate update, the rate information identifying the material, a cost center using the material, and a rate of the cost center and creates a rate update notification containing financial data including the rate information; and
asynchronously sending at least one of the price update, the quantity update, and the rate update notifications to the accounting system.
